(19) United States
(12) Patent Application Publication
(10) Pub. No.: US 2025/0224173 A1
(43) Pub. Date: Jul. 10, 2025

(54) REFRIGERATOR

(71) Applicant: SAMSUNG ELECTRONICS CO., LTD., Suwon-si (KR)

(72) Inventors: Byoungmok KIM, Suwon-si (KR); Jihoo KIM, Suwon-si (KR); Seokjun SON, Suwon-si (KR); Byoungjae CHO, Suwon-si (KR); Sungsoo SHIN, Suwon-si (KR)

(73) Assignee: SAMSUNG ELECTRONICS CO., LTD., Suwon-si (KR)

(21) Appl. No.: 19/032,859

(22) Filed: Jan. 21, 2025

Related U.S. Application Data
(63) Continuation of application No. PCT/KR2024/019071, filed on Nov. 28, 2024.

(30) Foreign Application Priority Data
Jan. 5, 2024 (KR) 10-2024-0002520
Mar. 21, 2024 (KR) 10-2024-0039102

(51) Int. Cl. F25D 23/02

(52) U.S. Cl. CPC F25D 23/028; F25D 2323/021

(57) ABSTRACT

A refrigerator includes a main body including a storage compartment, a first door and a second door rotatably connected to the main body to open or close the storage compartment, and a rotating bar rotatably coupled to the first door and configured to cover a gap between the first door and the second door, and the rotating bar includes a cam device coupled to the first door, and a rotating bar body coupled to the cam device and rotatable, and the cam device includes a hinge protrusion coupled to the first door, a fixed cam connected to the hinge protrusion, a rotary cam rotatably connected to the fixed cam, and an elastic member configured to elastically contact the fixed cam with the rotary cam, and the fixed cam, the rotary cam, and the elastic member are arranged on the same axis of rotation.

### CROSS-REFERENCE TO RELATED APPLICATIONS

This application is a continuation of International Application No. PCT/KR2024/019071, filed Nov. 28, 2024, which is incorporated herein by reference in its entirety, and claims priority to Korean Application No. 10-2024-0002520, filed Jan. 5, 2024, and Korean Application No. 10-2024-0039102, filed Mar. 21, 2024, which are incorporated herein by reference in their entireties.

### TECHNICAL FIELD

The disclosure relates to a refrigerator.

### BACKGROUND ART

In general, a refrigerator, an appliance for keeping food fresh, includes a main body with a storage compartment, a cold air supply device for supplying cold air to the storage compartment, and a door for opening and closing the storage compartment.

The storage compartment typically has an open front for inserting or removing food, and the open front of the storage compartment is opened and closed by the door. When the door is open, cold air inside the storage compartment escapes and warm air outside the storage compartment enters the storage compartment, thereby raising the temperature of the storage compartment.

The temperature of the storage compartment needs to be maintained within a certain range to keep food fresh. An increase in the temperature of the storage compartment may cause problems in keeping the food fresh, and additional energy may be consumed to reduce the temperature of the storage compartment to a normal temperature.

For example, a French door refrigerator (hereinafter referred to as a FDR refrigerator) may include a rotating bar rotatably coupled to a left door or a right door to prevent cold air from leaking through a gap between the left door and the right door.

### DISCLOSURE

### Technical Problem

An aspect of the present disclosure provides a refrigerator capable of reducing an operating rate of a heater of a rotating bar by applying a material with a low thermal conductivity to the rotating bar.

Further, an aspect of the present disclosure provides a refrigerator capable of ensuring a tight fit between a door gasket and a rotating bar by including a magnet inside the rotating bar.

Further, an aspect of the present disclosure provides a refrigerator including a cam structure with a small space for rotation to provide an insulating space.

Technical tasks to be achieved in this document are not limited to the technical tasks mentioned above, and other technical tasks not mentioned will be clearly understood by those skilled in the art from the description below.

### Technical Solution

According to an embodiment of the present disclosure, a refrigerator may include a main body including a storage compartment, a first door and a second door rotatably connected to the main body to open or close the storage compartment, and a rotating bar coupled to the first door so as to be rotatable with respect to the first door about an axis of rotation and configured to cover a gap between the first door and the second door when the first door and the second door are both closed. According to an embodiment of the present disclosure, the rotating bar may include a cam device coupled to the first door and including a hinge protrusion coupled to the first door, a fixed cam connected to the hinge protrusion and centered on the axis of rotation, a rotary cam that is rotatable with respect to the fixed cam about the axis of rotation, and an elastic member centered on the axis of rotation and configured to elastically contact the fixed cam with the rotary cam so that linear motion of the rotary cam is converted into rotary motion of the rotary cam by the contact of the fixed cam with the rotary cam. According to an embodiment of the present disclosure, the rotating bar may also include a rotating bar body coupled to the cam device so that rotation force formed by the rotary motion of the rotary cam transferred to the rotating bar body to rotate the rotating bar.

According to an embodiment of the present disclosure, a refrigerator includes a main body including a storage compartment, a first door and a second door rotatably connectable to the main body to open or close the storage compartment, and a rotating bar rotatably couplable to the first door and configured to cover a gap between the first door and the second door, and the rotating bar includes a cam device couplable to the first door, and a rotating bar body couplable to the cam device and rotatably disposed, and the cam device includes a hinge protrusion couplable to the first door, a fixed cam connected to the hinge protrusion, a rotary cam configured to be rotatable with respect to the fixed cam, and an elastic member configured to elastically contact the fixed cam with the rotary cam, and the fixed cam, the rotary cam, and the elastic member are arranged on the same axis of rotation.

According to an embodiment of the present disclosure, a refrigerator includes a main body including a storage compartment, a first door, a second door, a cam device coupled to the first door, and a rotating bar including a rotating bar body couplable to the cam device and configured to cover a gap between the first door and the second door, and the cam device includes a hinge protrusion fixed to the first door, a fixed cam connected to the hinge protrusion, a rotary cam configured to be rotatable together with the rotating bar body with respect to the fixed cam, and an elastic member configured to elastically contact the fixed cam with the rotary cam, and the rotary cam is configured to rotate between a first position where the rotating bar body is arranged when the first door is closed, and a second position where the rotating bar body is arranged when the first door is open, and the elastic member has a maximum elastic force at a critical position, wherein the distance between the fixed cam and the rotary cam approaches and then recedes between the first position and the second position of the rotary cam, and the rotating bar body includes an insulating space corresponding to the gap between the first door and the second door and including an insulating material, and a rotating space disposed between the hinge protrusion and the insulating space, and the fixed cam, the rotary cam, and the elastic member are arranged on the same axis of rotation in the rotating space.

According to an embodiment of the present disclosure, a refrigerator includes a main body including a storage compartment, a first door and a second door rotatably connected to the main body to open or close the storage compartment, a rotating bar rotatably mounted to the first door and configured to be rotatable on the first door to cover a gap between the first door and the second door, and the rotating bar includes a cam device couplable to the first door, a rotating bar body couplable to the cam device and configured to be rotatable, and a rotating bar magnet magnetically interacting with the first door and the second door, and the cam device includes a fixed cam including a fixed cam protrusion arranged to form a fixed cam peak and a fixed cam valley along a rotational direction of the cam device, and a rotary cam including a rotary cam protrusion arranged to form a rotary cam peak and a rotary cam valley along the rotational direction of the cam device, wherein the rotary cam is configured to rotate between a first position in which the rotary cam peak is disposed to correspond to the fixed cam valley when the first door is closed, and a second position in which the rotary cam peak is disposed to correspond to a different fixed cam valley adjacent to the fixed cam valley when the first door is open.

### Advantageous Effects

According to various embodiments of the present disclosure, the rotation radius of the cam device may be reduced to minimize the space for rotation of the rotating bar body.

Further, according to various embodiments of the present disclosure, the rotation radius of the cam device is reduced to minimize the space for rotation of the rotating bar body and to ensure a tight fit between the rotating bar and the first door and the second door.

The effects that can be obtained from the present disclosure are not limited to those mentioned above, and other effects not mentioned will be apparent to those of skilled in the art from the following description.

### DESCRIPTION OF DRAWINGS

FIG. 1 is a perspective view illustrating a refrigerator according to an embodiment.

FIG. 2 is a perspective view illustrating the refrigerator according to an embodiment.

FIG. 3 is an exploded view illustrating a door and a rotating bar coupled to the door of the refrigerator according to an embodiment.

FIG. 4 is a partial cross-sectional view illustrating the refrigerator according to an embodiment.

FIG. 5 is a partial cross-sectional view illustrating the refrigerator according to an embodiment.

FIG. 6 is a perspective view of the rotating bar of the refrigerator, according to an embodiment.

FIG. 7 is an exploded view of the rotating bar of the refrigerator, according to an embodiment.

FIG. 8 is an exploded view of the rotating bar of the refrigerator, according to one embodiment.

FIG. 9 is a perspective view of a cam device of the rotating bar of the refrigerator according to an embodiment.

FIG. 10 is an exploded view of the cam device of the rotating bar of the refrigerator according to an embodiment.

FIG. 11 is a cross-sectional view of the cam device of the rotating bar of the refrigerator according to an embodiment.

FIG. 12 is a cross-sectional view of the cam device of the rotating bar of the refrigerator according to an embodiment.

FIG. 13 is a cross-sectional view of the cam device of the rotating bar of the refrigerator according to an embodiment.

FIG. 14 is a partial cross-sectional view of the refrigerator according to one embodiment.

FIG. 15 is a partial cross-sectional view of the refrigerator according to an embodiment.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B”, “A, B or C”, “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1st”, “2nd”, “primary”, or “secondary” may be used simply to distinguish a component from other components, without limiting the component in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of each component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

A refrigerator according to an embodiment of the disclosure may include a main body.

The main body may include an inner case an outer case disposed outside the inner case, and an insulation between the inner case and the outer case.

The “inner case” may include at least one of a case, plate, panel, and liner forming the storage compartment. The inner case may be formed as a single body, or may be formed by assembling a plurality of plates. The “outer case” may form an outer appearance of the main body, and may be coupled to the outside of the inner case so that insulation is placed between the inner case and the outer case.

The insulation may insulate inside of a storage compartment from outside of the storage compartment to maintain inside temperature of the storage compartment at appropriate temperature without being influenced by an external environment of the storage compartment. According to an embodiment of the disclosure, the insulation may include a foaming insulation such as a polyurethane foam.

According to an embodiment of the disclosure, the insulation may include a vacuum insulation in addition to a foaming insulation, or may be configured only with a vacuum insulation instead of a forming insulation. Vacuum insulation may include a core material and an outer shell material that accommodates the core material and seals the interior at a vacuum or a pressure close to vacuum. However, the insulation is not limited to the foam insulation material or vacuum insulation material described above, and may include various materials that can be used for insulation.

The storage compartment may store a variety of items, such as foods, medicines, cosmetics, and the like, and the storage compartment may be formed to be open on at least one side for storing or removing items.

The refrigerator may include one or more storage compartments. In a case in which two or more storage compartments are formed in the refrigerator, the respective storage compartments may have different purposes of use, and may be maintained at different temperature. To this end, the storage compartments may be partitioned by a partition wall including an insulation.

The storage compartment may be maintained within an appropriate temperature range according to a purpose of use, and include a “refrigerating compartment”, a “freezing compartment”, and a “temperature conversion compartment” according to purposes of use and/or temperature ranges. The refrigerating compartment may be maintained at appropriate temperature to keep food refrigerating, and the freezing compartment may be maintained at appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of −20 degrees Celsius to −1 degrees Celsius. The temperature conversion compartment may be used as any one of a refrigerating compartment or a freezing compartment according to or regardless of a user's selection.

The storage compartment may also be called various other terms, such as “vegetable compartment (also referred to as room)”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below need to be understood to represent storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted on the front of the main body.

The door may seal the storage compartment in a closed state. The door may include an insulation, like the main body, to insulate the storage compartment in the closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forms the front surface of the door. The door body may include an outer door plate that forms the front surface of the door body, an inner door plate that forms the rear surface of the door body and faces the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or One Door Refrigerator depending on the arrangement of the doors and the storage compartments.

The refrigerator according to an embodiment of the disclosure may include a cold air supply device for supplying cold air to the storage compartment.

The cold air supply device may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a cooling cycle device having a compressor, a condenser, an expander, and an evaporator to drive the cooling cycle. According to an embodiment of the disclosure, the cold air supply device may include a semiconductor such as a thermoelectric element. The thermoelectric element may cool the storage compartment by heating and cooling actions through the Peltier effect.

The refrigerator according to an embodiment of the disclosure may include a machine compartment where at least some components belonging to the cold air supply device are installed.

The machine compartment may be partitioned and insulated from the storage compartment to prevent heat generated from the components installed in the machine compartment from being transferred to the storage compartment. To dissipate heat from the components installed inside the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice generated in the ice-making tray.

The refrigerator according to an embodiment of the disclosure may include a controller for controlling the refrigerator.

The controller may include a memory for storing and/or memorizing data and/or programs for controlling the refrigerator, and a processor for outputting control signals for controlling the cold air supply device, etc. according to the programs and/or data memorized in the memory.

The memory may store or record various information, data, commands, programs, and the like necessary for operations of the refrigerator. The memory may store temporary data generated while generating control signals for controlling components included in the refrigerator. The memory may include at least one of volatile memory or non-volatile memory, or a combination thereof.

The processor may control the overall operation of the refrigerator. The processor may control the components of the refrigerator by executing programs stored in memory. The processor may include a separate neural processing unit (NPU) that performs an operation of an artificial intelligence (AI) model. In addition, the processor may include a central processing unit (CPU), a graphics processor (GPU), and the like. The processor may generate a control signal to control the operation of the cold air supply device. For example, the processor may receive temperature information of the storage compartment from a temperature sensor, and generate a cooling control signal for controlling an operation of the cold air supply device based on the temperature information of the storage compartment.

Furthermore, the processor may process a user input of a user interface and control an operation of the user interface according to the programs and/or data memorized/stored in the memory. The user interface may be provided using an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all the components included in the refrigerator, and may include a plurality of processors and a plurality of memories for individually controlling the components of the refrigerator. For example, the refrigerator may include a processor and a memory for controlling the operation of the cold air supply device according to an output of the temperature sensor. In addition, the refrigerator may be separately equipped with a processor and a memory for controlling the operation of the user interface according to the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, various embodiments according to the disclosure will be described in detail with reference to the accompanying drawings.

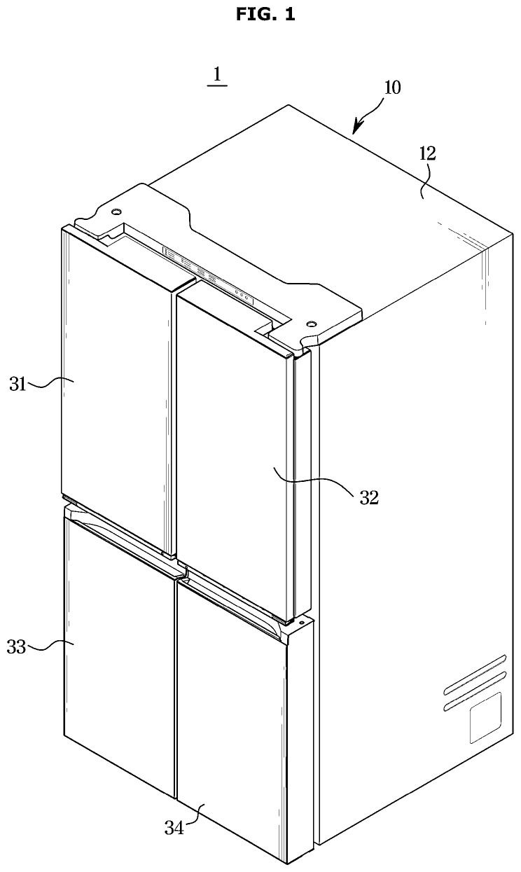

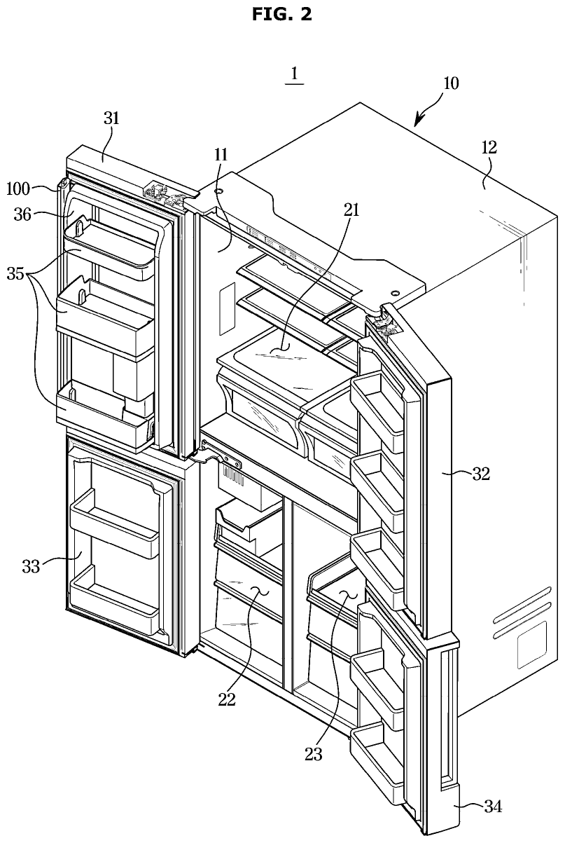

FIGS. 1 and 2 are perspective views illustrating a refrigerator 1 according to an embodiment. In particular, FIG. 1 shows a door of the refrigerator 1 according to an embodiment being closed, and FIG. 2 1 shows the door of the refrigerator 1 according to an embodiment being opened.

Referring to FIGS. 1 and 2, the refrigerator 1 may include a main body 10, a plurality of storage compartments 21, 22 and 23 disposed within the main body 10, a plurality of doors 31, 32, 33 and 34 for opening or closing the plurality of storage compartments 21, 22 and 23, and a cold air supply device for supplying cold air to the plurality of storage compartments 21, 22 and 23.

The main body 10 may include an inner case 11 forming the plurality of storage compartments 21, 22 and 23, an outer case 12 coupled to an outer side of the inner case 11 to form an exterior thereof, and an insulation disposed between the inner case 11 and the outer case 12 to thermally insulate the plurality of storage compartments 21, 22 and 23.

The plurality of storage compartments 21, 22 and 23 may be divided into a plurality of sections by a horizontal partition and a vertical partition. A plurality of shelves and storage containers may be provided inside the plurality of storage compartments 21, 22 and 23 to store food, and the like.

The storage compartment 20 may be divided into the plurality of storage compartments 21, 22 and 23 by partitions. In particular, the plurality of storage compartments 21, 22 and 23 may be divided by a horizontal partition into a first storage compartment 21 as an upper storage compartment, and a second storage compartment 22 and a third storage compartment 23 as lower storage compartments, wherein the lower storage compartment may be divided by a vertical partition into the second storage compartment 22 and the third storage compartment 23.

The first storage compartment 21 may be used as a refrigerating compartment. The second storage compartment 22 and the third storage compartment 23 may be used as freezing compartments. Although the second storage compartment 22 and the second storage compartment 22 may be used as freezing compartments, the second storage compartment 22 may be used as a freezing compartment and the third storage compartment 23 may be used as a refrigerating compartment, or the second storage compartment 22 may be used as a freezing compartment and the third storage compartment 23 may be used as either a freezing compartment or a refrigerating compartment. However, such a divided use of the plurality of storage compartments 21, 22 and 23 is merely an example and is not limited thereto.

The cold air supply device may generate cold air using a cooling cycle of compressing, condensing, expanding, and evaporating a refrigerant, and supply the generated cold air to the plurality of storage compartments 21, 22 and 23.

The plurality of storage compartments 21, 22 and 23 may be opened or closed by the plurality of doors 31, 32, 33 and 34. The plurality of doors 31, 32, 33 and 34 may include a first door 31 and a second door 32 for opening or closing the upper storage compartment 20, and a pair of a third door 33 and a fourth door 34 for opening or closing the lower storage compartment 20. In an example, the first door 31 and the second door 32 may open or close the first storage compartment 21, the third door 33 may open or close the second storage compartment 22, and the fourth door 34 may open or close the third storage compartment 23.

In the following, for ease of description, only one first door 31 will be described, and the description of the remaining second doors will be omitted. However, the second door 32 for which the description is omitted, may have substantially the same configuration as the first door 31 described below, except that it is arranged in a mirror symmetric manner. In addition, the second door 32 may also include the same configuration as the first door 31, and further description may be omitted.

The first storage compartment 21 may be opened or closed by the first door 31 rotatably coupled to the main body 10. The first door 31 may include a door shelf 35 for storing food. The first door 31 may include a shelf support member 36 disposed on opposite sides of the door shelf 35 to support the door shelf 35. The shelf support member 36 may be formed in an approximately rectangular frame shape at a rear surface of the first door 31. The first door 31 may include a plurality of shelf mounting portions 37 arranged to be spaced apart at given intervals and protruding from an inner surface of the shelf support member 36.

The first door 31 may include a first door gasket 31a disposed on a rear edge of the first door 31 to seal a gap with the main body 10 when the first door 31 is in a closed state. The second door 32 may include a second door gasket 32a disposed on a rear edge of the second door 32 to seal a gap with the main body 10 when the second door 32 is in a closed state. In particular, the first door gasket 31a may be disposed in a loop shape along the rear edge of the first door 31, and the second door gasket 32a may be disposed in a loop shape along the rear edge of the second door 32.

Based on the first door 31 and the second door 32 being in the closed state, a gap may be formed between the first door 31 and the second door 32. The gap formed between the first door 31 and the second door 32 may cause cold air inside the refrigerator 1 to escape to the outside, resulting in a decrease in thermal efficiency.

To address such a matter, the refrigerator 1 according to an embodiment may include a rotating bar 100 coupled to at least one of the first door 31 and the second door 32. The rotating bar 100 may cover the gap formed between the first door 31 and the second door 32. For ease of description, the rotating bar 100 will be described herein with reference to the rotating bar 100 coupled to the first door 31.

The rotating bar 100 may be arranged as shown in FIG. 2 in response to opening of the first door 31, and may rotate to cover the gap between the first door 31 and the second door 32 in response to closing of the first door 31.

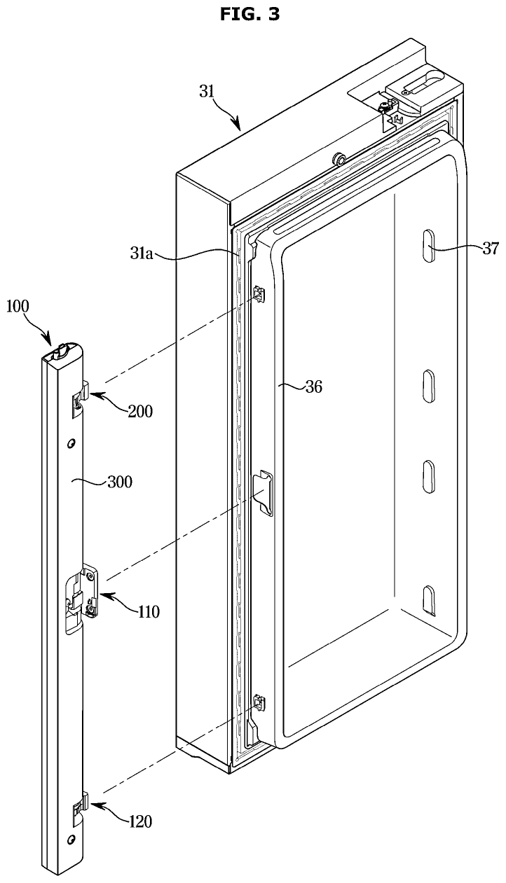

FIG. 3 is an exploded perspective view showing the first door 31 and the rotating bar 100 coupled to the first door 31 of the refrigerator 1 according to an embodiment.

Referring to FIG. 3, the rotating bar 100 may be coupled to or uncoupled from the first door 31. The rotating bar 100 may include a cam device 200 and hinge members 110 and 120 coupled to the first door 31, and may include a rotating bar body 300 forming the exterior of the rotating bar 100. The cam device 200 and the hinge members 110 and 120 may be couplable and rotatable to allow a portion thereof to be secured to the first door 31. While the drawings show the cam device 200 and the hinge members 110 and 120 including two, the cam device 200 may be included only, and the number of hinge members 110 and 120 may be different. Furthermore, the position of the cam device 200 and the arrangement of the cam device 200 and the hinge members 110 and 120 are shown in the drawings only as an example and may be arranged in a variety of ways.

An upper portion of the first door 31 may be provided with a first door 31 coupling portion coupled with the main body 10 to allow the first door 31 to rotate. Although not shown in the drawings, a coupling portion for coupling with the main body 10 may also be provided on a lower portion of the first door 31.

The rotating bar 100 may be formed in the shape of an elongated bar in a vertical direction. The rotating bar body 300 may include a plurality of grooves for coupling the cam device 200 and the hinge members 110 and 120. The cam device 200 and the hinge members 110 and 120 may be coupled to the plurality of grooves.

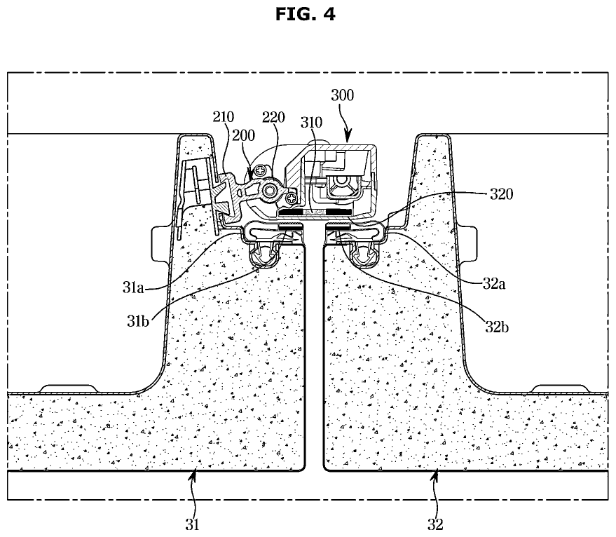

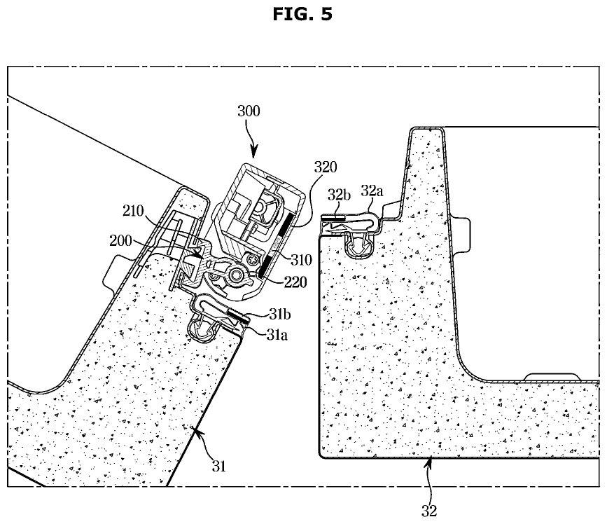

FIGS. 4 and 5 are partial cross-sectional views of the refrigerator 1 according to an embodiment. In particular, FIG. 4 is an enlarged cross-sectional view of a portion where the first door 31 and the second door 32 face each other when the doors 31 and 32 are closed, and FIG. 5 is an enlarged cross-sectional view of a portion where the first door 31 and the second door 32 face each other when the first door 31 is open or is opening.

Referring to FIGS. 4 and 5, the plurality of doors 31, 32, 33 and 34 may include the first door 31 and the second door 32. The first door 31 may include the first door gasket 31a and a first gasket magnet 31b provided within the first door gasket 31a, and the second door 32 may include the second door gasket 32a and a second gasket magnet 32b provided within the second door gasket 32a. The rotating bar 100 may include a rotating bar magnet 310 that magnetically interacts with the first door gasket magnet 31b and the second gasket magnet 32b.

The first door gasket 31a and the second door gasket 32a may be in close contact with the main body 10 and the rotating bar 100 to prevent cold air inside the first storage compartment 21 from escaping to the outside.

The first gasket magnet 31b and the second gasket magnet 32b may be disposed with equal magnetic poles with respect to the rotating bar 100. In other words, the first gasket magnet 31b and the second gasket magnet 32b may be arranged so that the same magnetic poles face the main body 10. Among the rotating bar magnets 310, a portion corresponding to the first gasket magnet 31b and the second gasket magnet 32b may have a magnetic pole opposite to the magnetic poles of the first gasket magnet 31b and the second gasket magnet 32b. In other words, the rotating bar magnet 310 may strengthen the tight fit between the rotating bar 100 and the first door 31 and between the rotating bar 100 and the second door 32 through its attractive force with the first gasket magnet 31b and the second gasket magnet 32b.

To exert an attractive force between the rotating bar magnet 310 and the first gasket magnet 31b and between the rotating bar magnet 310 and the second gasket magnet 32b, the rotating bar magnet 310 may be a three-pole magnet. For example, when a portion of the first gasket magnet 31b and the second gasket magnet 32b facing the main body 10 is the N-pole, the rotating bar magnet 310 may be a three-pole magnet arranged in the order of the S-pole, the N-pole, and the S-pole.

The cam device 200 may include a hinge protrusion 210 couplable to the first door 31, a fixed cam 220 connected to the hinge protrusion 210, a rotary cam 230 arranged to be rotatable relative to the fixed cam 220, and an elastic member 250 configured to elastically contact the fixed cam 220 with the rotary cam 230.

The fixed cam 220 may be connected to the hinge protrusion 210, such that the fixed cam 200 may be fixed without rotating relative to the first door 31. The fixed cam 220 may be formed in an approximately cylindrical shape. The rotary cam 230 may rotate relative to the fixed cam 220.

The elastic member 250 may have one end fixed to a portion of the cam device 200 and the other end contacting the rotary cam 230 to transmit an elastic force to the rotary cam 230. The rotary cam 230 may convert linear motion of the rotary cam 230 into rotary motion of the rotary cam 230 by interacting with the fixed cam 220 via the elastic force transmitted from the elastic member 250. More specifically, the elastic member 250 may be configured to elastically contact the fixed cam 220 with the rotary cam 230 so that linear motion of the rotary cam 230 is converted into rotary motion of the rotary cam 230 by the contact of the fixed cam 220 with the rotary cam 230. The rotational force formed by the interaction between the fixed cam 220 and the rotary cam 230 may be transmitted to the rotating bar body 300 to rotate the rotating bar 100. That is, rotation force formed by the rotary motion of the rotary cam 230 may be transferred to the rotating bar body 300 to rotate the rotating bar 100.

The rotating bar 100 may include an insulating member filled on the inside of the rotating bar body 300 and a heating member 320 that prevents dew condensation caused by a temperature difference between the inside and the outside of the refrigerator 1.

The insulating member, the rotating bar magnet 310, the heating member 320, the first gasket magnet 31b, and the second gasket magnet 32b may be arranged in the order from the rear of the main body 10 to the front of the main body 10.

An angle between the rotating bar body 300 when the first door 31 is closed (see FIG. 4) and the rotating bar body 300 when the first door 31 is open (see FIG. 5) may be approximately vertical. In other words, when the first door 31 is open, the rotating bar body 300 may rotate counterclockwise with respect to the drawings, and when the first door 31 is closed, the rotating bar body 300 may rotate clockwise with respect to the drawing, so that the rotating bar body 300 may be arranged in the positions shown in FIGS. 4 and 5.

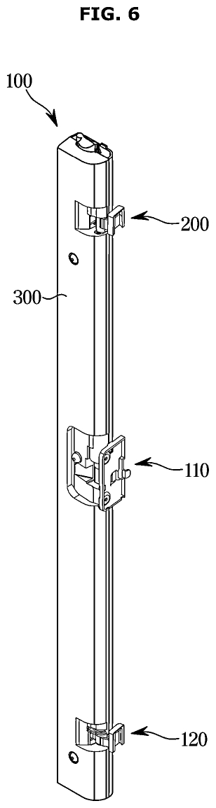

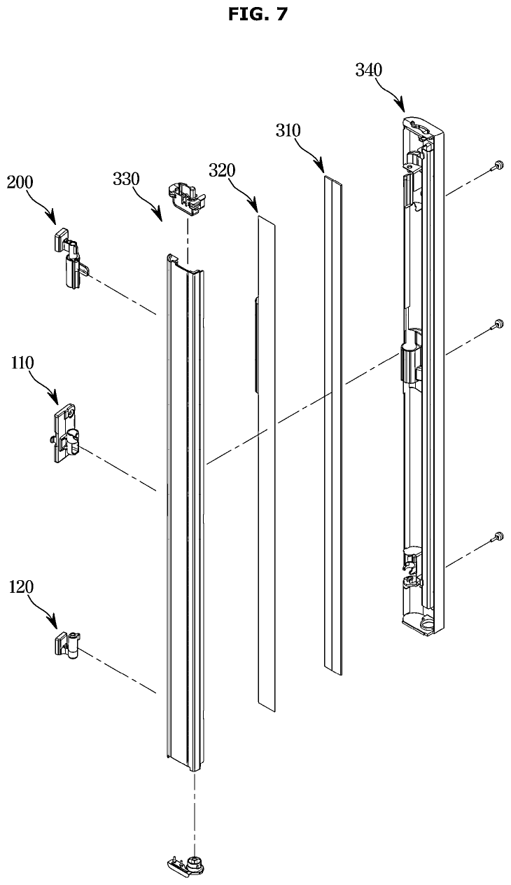

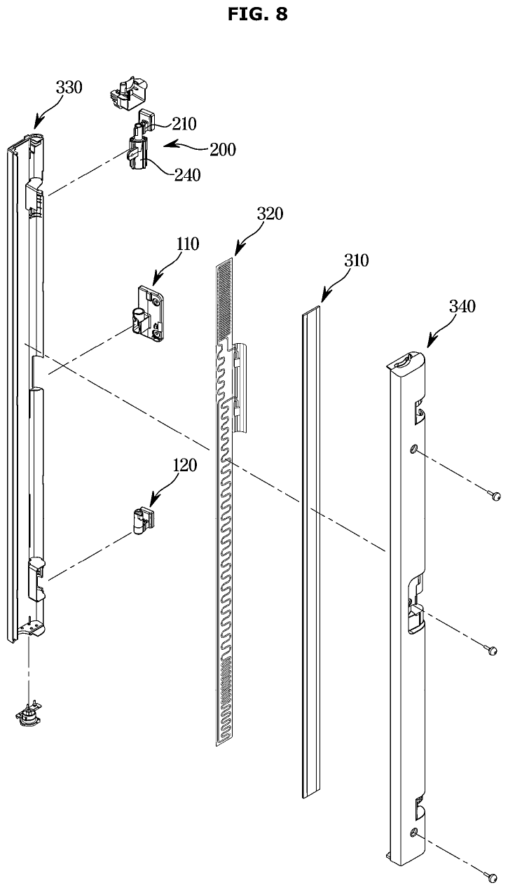

FIG. 6 is a perspective view of the rotating bar 100 of the refrigerator 1 according to an embodiment, and FIGS. 7 and 8 are exploded perspective views of the rotating bar 100 of the refrigerator 1 according to an embodiment.

Referring to FIG. 6, only the hinge at an upper end of the rotating bar is a cam device 200, and the other hinge members 110 and 120 do not employ the cam devices 200, but this is by way of an example only, and all of the hinge members 110 and 120 may be cam devices 200.

The cam device 200 and the hinge members 110 and 120 may be coupled to the first door 31 in a hook manner or the like, and thus may be detachable from the first door 31.

Referring to FIGS. 7 and 8, the cam device 200 may include a rotating bar front body 330 partially exposed to the outside of the refrigerator 1 when the first door 31 is closed, a rotating bar rear body 340 facing the main body 10, the heating member 320, the rotating bar magnet 310, the cam device 200, and the hinge members 110 and 120. In a direction from the front to the rear of the refrigerator 1, the rotating bar front body 330, the heating member 320, the rotating bar magnet 310, and the rotating bar rear body may be arranged in the followings order. The cam device 200 and the hinge members 110 and 120 may be coupled between the rotating bar front body 330 and the rotating bar rear body 340. A portion of the hinge members 110 and 120 may serve to supply power to the heating member 320 of the rotating bar 100, and the like.

The rotating bar front body 330 may include a plastic material in a portion exposed to the outside of the refrigerator 1 when the first door 31 is closed. By including a plastic material with a relatively low thermal conductivity, the rotating bar front body 330 may prevent the thermal efficiency from decreasing. However, it is not necessary to use a plastic material, and it is sufficient to include a material with a sufficiently low thermal conductivity.

While the drawings show the rotating bar front body 330 and the rotating bar rear body 340 being coupled by screws, but the coupling method is not limited thereto, and it is sufficient as long as a method is used that may reliably couple the rotating bar body 300, the cam device 200, and the hinge members 110 and 120.

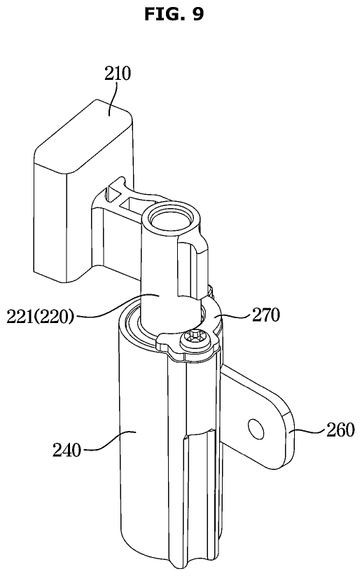

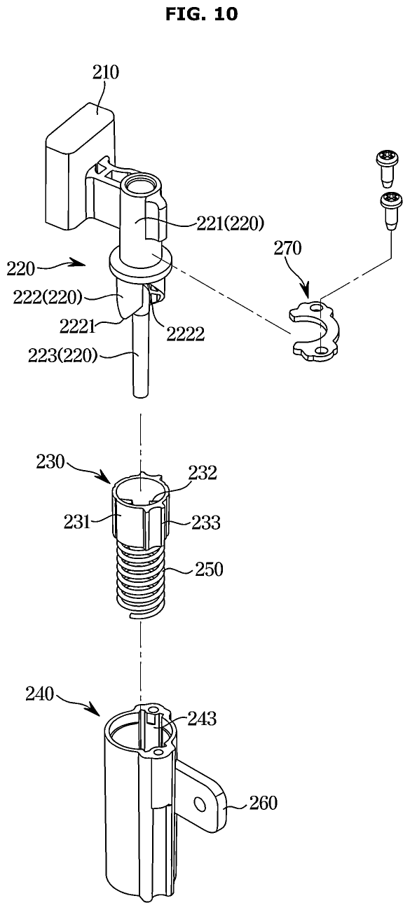

FIG. 9 is a perspective view of the cam device 200 of the rotating bar 100 of the refrigerator 1 according to an embodiment, and FIG. 10 is an exploded perspective view of the cam device 200 of the rotating bar 100 of the refrigerator 1 according to an embodiment.

Referring to FIGS. 9 and 10, the cam device 200 may include the hinge protrusion 210 coupled to the first door 31, the fixed cam 220 connected to the hinge protrusion 210, the rotary cam 230 connected to the fixed cam 220, a rotary cam housing 240 covering a portion of the fixed cam 220 and the rotary cam 230 and the elastic member 250, a connecting rib 260 protruding from an outer surface of the rotary cam housing 240, and a cam coupling body 270 securing the rotary cam housing 240 and the fixed cam 220. As can be seen in FIGS. 9 and 10, the fixed cam 220 and the elastic member 250 may be centered on the axis of rotation of the rotating bar 100, and the rotating cam 230 may be rotatable about the axis of rotation of the rotating bar 100.

The fixed cam 220 may include a fixed cam body 221 connected to the hinge protrusion 210, and a fixed cam protrusion 222 protruding from an end of the fixed cam body 221. The fixed cam protrusion 222 may form a fixed cam peak 2221 disposed far relative to the fixed cam body 221, and a fixed cam valley 2222 disposed close relative to the fixed cam body 221. In other words, the fixed cam peak 2221 and the fixed cam valley 2222 may be disposed along a rotational direction of the cam device 200 relative to an axis of rotation of the rotating bar 100. The fixed cam protrusion 222 may form a shape in which the fixed cam peak 2221 and the fixed cam valley 2222 are repeated, thereby allowing the fixed cam 220 to act as a cam.

The fixed cam 220 may include a rotating shaft 223 formed to protrude from the fixed cam body 221. The rotating shaft 223 may serve to prevent the fixed cam 220, the rotary cam 230, the elastic member 250, and the rotary cam housing 240 from deviating from their original positions with respect to the axis of rotation of the rotating bar 100. In the present disclosure, the rotating shaft 223 is shown as being included in the fixed cam 220, but the rotating shaft 223 may be formed in the rotary cam 230 or may be included in the cam device 200 as a separate member.

The rotary cam 230 may include a rotary cam body 231 forming an exterior thereof, and a rotary cam protrusion 232 formed along an inner circumferential surface of the rotary cam body 231 along a circumferential direction of the cam device 200. The rotary cam protrusion 232 may form a rotary cam peak 2321 and a rotary cam valley 2322, similar to the fixed cam 220.

The rotary cam 230 may be positioned at a first position P1 where the rotary cam peak 2321 and the fixed cam valley 2222 are positioned to correspond when the first door 31 is closed. When the first door 31 is open, the rotary cam 230 may be rotated to a second position P2 in which the rotary cam peak 2321 is positioned at another fixed cam valley 2222 adjacent to the fixed cam valley 2222 when the first door 31 is closed. The rotary cam 230 may be positioned at a critical position C where the rotary cam peak 2321 and the fixed cam peak 2221 correspond between the first position P1 and the second position P2 and the elastic force of the elastic member 250 is maximum.

The rotary cam 230 may include a guide protrusion 233 protruding from an outer circumferential surface of the rotary cam body 231. The guide protrusion 233 may transmit the rotational force of the rotary cam 230 to the rotating bar body 300 through the rotary cam housing 240.

The elastic member 250 may be a coil spring. However, the present disclosure is not necessarily limited thereto, and it is sufficient if the elastic member 250 may provide an elastic force to the rotary cam 230 to allow the rotary cam 230 to rotate smoothly between the first position P1 and the second position P2.

The rotary cam housing 240 may be formed in the shape of a hollow cylinder. The rotary cam housing 240 may cover a portion of the fixed cam 220, the rotary cam 230, and the elastic member 250. The rotary cam housing 240 may include a guide groove 243 that is recessedly formed to correspond to the guide protrusion 233 in order to receive the rotational force of the rotary cam 230.

The connecting rib 260 may transmit the rotational force formed by the interaction of the fixed cam 220 and the rotary cam 230 to the rotating bar body 300. In other words, the rotational force of the rotary cam 230 formed by utilizing the elastic force of the elastic member 250 relative to the fixed cam 220 may be transmitted to the rotating bar body 300 through the connecting rib 260 formed integrally with the rotary cam housing 240.

The connecting rib 260 may include a threaded hole formed to be secured to the rotating bar body 300. However, the method of coupling between the connecting rib 260 and the rotating bar body 300 is not limited thereto, and various methods, such as a protrusion and groove coupling method may be applied.

The cam coupling body 270 may couple the fixed cam 220 and the rotary cam housing 240 to prevent the components inside the rotary cam housing 240 from being disassembled to the outside due to the elastic force of the elastic member 250. In particular, the cam coupling body 270 may support a portion of the fixed cam body 221 and a portion of the rotary cam housing 240 and may be coupled to the rotary cam housing 240 via a separate member. However, this is merely an example of arranging the components of the cam device 200 such that they are not disassembled, and thus, the present disclosure is not limited thereto, and the components of the cam device 200 may be coupled in a variety of ways.

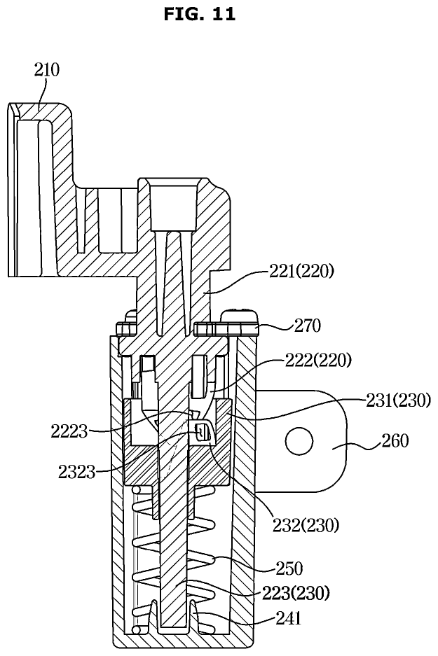

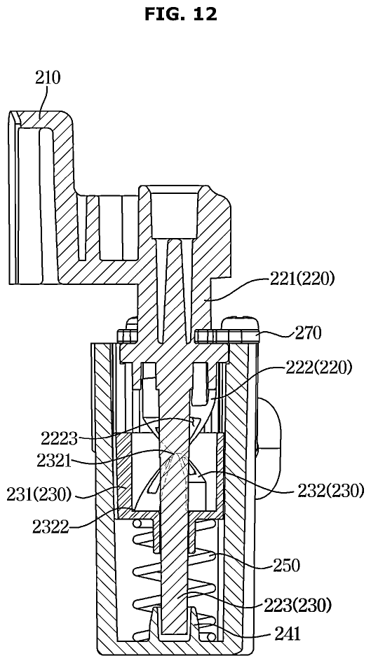

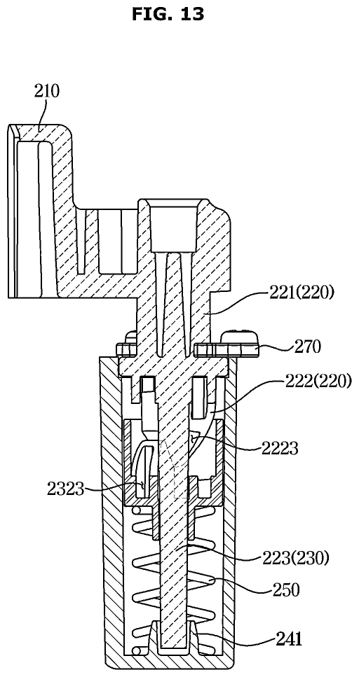

FIGS. 11 to 13 are cross-sectional views of the cam device 200 of the rotating bar 100 of the refrigerator 1 according to an embodiment. In particular, FIG. 11 is a view showing the first position P1 of the rotary cam 230, FIG. 12 is a view showing the critical position C of the rotary cam 230, and FIG. 13 is a view showing the second position P2 of the rotary cam 230.

The rotary cam housing 240 may include a shaft fixing protrusion 241 that may receive the rotating shaft 223. The shaft fixing protrusion 241 may position the rotating shaft 223 approximately in the middle of the rotary cam housing 240 to allow the fixed cam 220 and the rotary cam 230 to interact smoothly.

The connecting rib 260 may rotate about the axis of rotation between the first position P1 and the second position P2 to rotate the rotating bar body 300. When the rotary cam 230 is moved a predetermined distance from the critical position C toward the first position P1, it may be moved to the first position P1 by an elastic force, and when the rotary cam 230 is moved a predetermined distance from the critical position C toward the second position P2, it may be moved to the second position P2 by an elastic force.

The fixed cam protrusion 222 may include a first anti-friction groove 2223 formed on an inclined surface between the fixed cam peak 2221 and the fixed cam valley 2222. The first anti-friction groove 2223 may reduce the contact area between the fixed cam protrusion 222 and the rotary cam protrusion 232 to facilitate the rotation of the rotary cam 230.

The rotary cam protrusion 232 may include a second anti-friction groove 2323 formed on an inclined surface between the rotary cam peak 2321 and the rotary cam valley 2322. The second anti-friction groove 2323 may reduce the contact area between the rotary cam protrusion 232 and the fixed cam protrusion 222 to facilitate the rotation of the rotary cam 230.

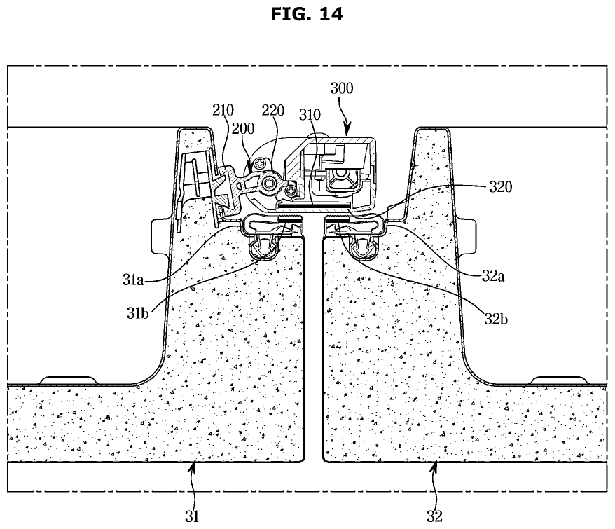

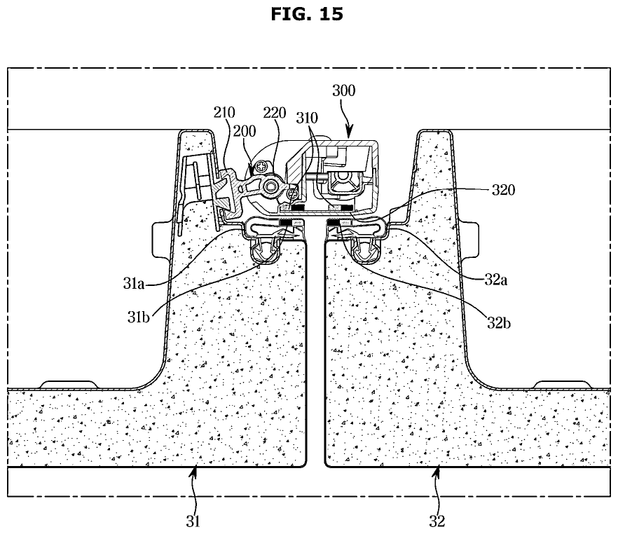

FIG. 14 and FIG. 15 are partial cross-sectional views of the refrigerator 1 according to an embodiment.

Referring to FIG. 14 and FIG. 15, the plurality of doors 31, 32, 33 and 34 may include the first door 31 and the second door 32. The first door 31 may include the first door gasket 31a and the first gasket magnet 31b disposed within the first door gasket 31a, and the second door 32 may include the second door gasket 32a and the second gasket magnet 32b disposed within the second door gasket 32a. The rotating bar 100 may include the rotating bar magnet 310 that magnetically interacts with the first door gasket magnet 31b and the second gasket magnet 32b.

Referring to FIG. 14, the magnetic poles of the first gasket magnet 31b, the second gasket magnet 32b, and the rotating bar magnet 310 may be arranged in the same direction. For example, in response to the magnetic poles of the first gasket magnet 31b and the second gasket magnet 32b toward the main body 10 being N-poles, the magnetic poles of the rotating bar magnet 310 toward the first gasket magnet 31b and the second gasket magnet 32b may be S-poles.

Referring to FIG. 15, the magnetic pole directions of the first gasket magnet 31b and the second gasket magnet 32b and the magnetic pole direction of the rotating bar magnet 310 may be arranged in opposite directions. For example, in response to the first gasket magnet 31b and the second gasket magnet 32b being arranged in the order of the N-pole and the S-pole in the direction from the first door 31 to the second door 32, the rotating bar magnet 310 may be arranged in the order of the S-pole and the-N pole in the direction from the first door 31 to the second door 32.

The types, numbers, and directions of magnetic poles of the first gasket magnet 31b, the second gasket magnet 32b, and the rotating bar magnet shown in FIGS. 1 to 15 are only examples. In other words, it is sufficient if the first gasket magnet 31b, the second gasket magnet 32b, and the rotating bar magnet 310 are formed to form an attractive force between the rotating bar 100 and the first door 31, and between the rotating bar 100 and the second door 32.

The refrigerator 1 according to an embodiment may include the main body 10 including the storage compartment 20, the first door 31 and the second door 32 rotatably connectable to the main body 10 to open or close the storage compartment 20, the rotating bar 100 rotatably couplable to the first door 31 and configured to cover the gap between the first door 31 and the second door 32, and the rotating bar 100 may include the cam device 200 couplable to the first door 31, the rotating bar body 300 couplable to the cam device 200 and disposed to be rotatable, and the cam device 200 may include the hinge protrusion 210 couplable to the first door 31, the fixed cam 220 connectable to the hinge protrusion 210, the rotary cam 230 rotatably connectable to the fixed cam 220, and the elastic member 250 elastically contacting the cam 220 with the rotary cam 230. The fixed cam 220, the rotary cam 230, and the elastic member 250 may be arranged on the same axis of rotation.

The rotating bar body 300 may include the insulating space corresponding to the gap between the first door 31 and the second door 32 and including an insulating material, and the rotating space disposed between the hinge protrusion 210 and the insulating space, and the fixed cam 220, the rotary cam 230, and the elastic member 250 may be arranged in the rotating space. According to the present disclosure, by separating the insulating space and the rotating space, heat loss caused by the gap between the first door 31 and the second door 32 may be reduced.

The cam device 200 may further include the rotary cam housing 240 configured to cover an outer circumferential surface of the rotary cam 230, and the elastic member 250 may be configured such that one end of the elastic member 250 is supported on an inner surface of the rotary cam housing 240, and the other end of the elastic member 250 is supported on the rotary cam 230 so as to apply an elastic force to the rotary cam 230.

The fixed cam 220 may include the fixed cam body 221 connectable to the hinge protrusion 210, and the fixed cam protrusion 222 configured to form the fixed cam peak 2221 and the fixed cam valley 2222 along a circumferential direction of the cam device 200 at an end of the fixed cam body 221, and the rotary cam 230 may include the rotary cam body 231 forming an exterior thereof, and the rotary cam protrusion 232 configured to form the rotary cam peak 2321 and the rotary cam valley 2322 along the circumferential direction of the cam device 200.

The rotary cam 230 may be configured to rotate between the first position P1 where the rotary cam peak 2321 is arranged to correspond to the fixed cam valley 2222 when the first door 31 is closed, and the second position P2 where the rotary cam peak 2321 is arranged to correspond to another fixed cam valley 2222 adjacent to the fixed cam valley 2222 when the first door 31 is open, and the elastic member 250 may be arranged such that the elastic force is maximum at the critical position C where the fixed cam peak 2221 and the rotary cam peak 2321 correspond to each other between the first position P1 and the second position P2 of the rotary cam 230.

The rotary cam 230 may include the guide protrusion 233 protruding from an outer circumferential surface of the rotary cam body 231, and the rotary cam housing 240 may include the guide groove 243 recessedly formed to correspond to the guide protrusion 233 to allow the guide protrusion 233 to be moved in the direction in which the axis of rotation extends.

The cam device 200 may further include the connecting rib 260 protruding from an outer surface of the rotary cam housing 240, and to simultaneously rotate the rotary cam housing 240 and the rotating bar body 300, at least a portion of the connecting rib 260 may be supported on a portion of the rotating bar body 300.

The cam device 200 may further include the cam coupling body 270 that prevents the rotary cam 230 and the rotary cam housing 240 from being separated by the elastic force of the elastic member 250, and at least a portion of the fixed cam body 221 may be disposed between the cam coupling body 270 and the rotary cam housing 240.

The fixed cam protrusion 222 may include the first anti-friction groove 2223 configured to reduce the area of an inclined surface formed between the fixed cam peak 2221 and the fixed cam valley 2222 so as to reduce friction due to contact between the fixed cam protrusion 222 and the rotary cam protrusion 232, and the rotary cam protrusion 232 may include the second anti-friction groove 2323 configured to reduce the area of an inclined surface formed between the rotary cam peak 2321 and the rotary cam valley 2322 so as to reduce friction due to contact between the rotary cam protrusion 232 and the fixed cam protrusion 222.

The rotating bar 100 may further include the rotating bar magnet 310 that magnetically interacts with the first door 31 and the second door 32, and the heating member 320 that is disposed between the rotating bar magnet 310 and the rotating bar body 300 to prevent dew condensation on an outer surface of the rotating bar 100, and the rotating bar body 300 may include a plastic material in a portion adjacent to the heating member 320 and the rotating bar magnet 310. According to the present disclosure, a material having a low thermal conductivity is used in a portion corresponding to the gap between the first door 31 and the second door 32, thereby reducing heat loss.

The first door 31 may include the first door gasket 31a configured to apply a sealing force between the first door 31 and the main body 10 and the first door 31 and the rotating bar 100, and the first door gasket 31a may include the first gasket magnet 31b configured to be coupled by magnetic interaction with the rotating bar magnet 310. The second door 32 may include the second door gasket 32a configured to apply a sealing force between the second door 32 and the main body 10 and the second door 32 and the rotating bar 100, and the second door gasket 32a may include the second gasket magnet 32b configured to be coupled by magnetic interaction with the rotating bar magnet 310.

The first gasket magnet 31b and the second gasket magnet 32b are arranged to have the same magnetic poles facing the main body 10, and the rotating bar magnet 310 may be a three-pole magnet in which the same magnetic poles as the magnetic poles of the first gasket and the second gasket magnet 32b corresponding to the rotating bar magnet 310 are arranged in the middle, and opposite magnetic poles are arranged on both sides. According to the present disclosure, heat loss may be reduced by ensuring a close contact between the rotating bar 100 and the first door 31 and the second door 32.

The refrigerator 1 according to an embodiment may include the main body 10 including the storage compartment 20, the first door 31, the second door 32, the cam device 200 couplable to the first door 31, and the rotating bar 100 including the rotating bar body 300 couplable to the cam device 200 and configured to cover a gap between the first door 31 and the second door 32, and the cam device 200 includes the hinge protrusion 210 securable to the first door 31, the fixed cam 220 connectable to the hinge protrusion 210, the rotary cam 230 configured to be rotatable together with the rotating bar body 300 with respect to the fixed cam 220, and the elastic member 250 configured to elastically contact the fixed cam 220 with the rotary cam 230, and the rotary cam 230 is configured to rotate between the first position P1 where the rotating bar body 300 is arranged when the first door 31 is closed, and the second position P2 where the rotating bar body 300 is arranged when the first door 31 is open, and the elastic member 250 has a maximum elastic force at the critical position C, wherein a distance between the fixed cam 220 and the rotary cam 230 approaches and then recedes between the first position P1 and the second position P2 of the rotary cam 230, and the rotating bar body 300 includes an insulating space corresponding to the gap between the first door 31 and the second door 32 and including an insulating material, and a rotating space disposed between the hinge protrusion 210 and the insulating space, and the fixed cam 220, the rotary cam 230, and the elastic member 250 are arranged on the same axis of rotation in the rotating space.

The rotating bar body 300 may further include the rotating bar magnet 310 that is coupled or separated through magnetic interaction with the first door 31 and the second door 32, and the first door 31 may include the first door gasket 31a configured to apply a sealing force between the first door 31 and the main body 10 and the first door 31 and the rotating bar 100, and the second door 32 may include the second door gasket 32a configured to apply a sealing force between the second door 32 and the main body 10 and the second door 32 and the rotating bar 100, and the first door gasket 31a may include the first gasket magnet 31b configured to be coupled by magnetic interaction with the rotating bar magnet 310, and the second door gasket 32a may include the second gasket magnet 32b configured to be coupled by magnetic interaction with the rotating bar magnet 310.

The rotating bar 100 may further include the heating member 320 disposed between the rotating bar magnet 310 and the rotating bar body 300 to prevent dew condensation on an outer surface of the rotating bar 100, and the rotating bar body 300 may include a plastic material in a portion adjacent to the heating member 320 and the rotating bar magnet 310.

The first gasket magnet 31b and the above second gasket magnet 32b are arranged such that the same magnetic poles are directed toward the main body 10, and the rotating bar magnet 310 may be a three-pole magnet in which the same magnetic poles as the magnetic poles of the first gasket and the second gasket magnet 32b corresponding to the rotating bar magnet 310 are arranged in the middle, and opposite magnetic poles are arranged on both sides.

The cam device 200 may further include the rotary cam housing 240 configured to cover an outer circumferential surface of the rotary cam 230, and the elastic member 250 may be configured such that one end of the elastic member 250 is supported on an inner surface of the rotary cam housing 240 and the other end of the elastic member 250 is supported on the rotary cam 230 so as to apply an elastic force to the rotary cam 230.

The rotary cam 230 may further include the rotary cam body 231 forming an exterior thereof, and the guide protrusion 233 protruding from an outer circumferential surface of the rotary cam body 231, and the rotary cam housing 240 may include the guide groove 243 recessedly formed to correspond to the guide protrusion 233 to allow the guide protrusion 233 to be moved in a direction in which the axis of rotation extends.

The refrigerator 1 according to an embodiment may include a main body 10 including a storage compartment 20, a first door 31 and a second door 32 rotatably connectable to the main body 10 to open or close the storage compartment 20, a rotating bar 100 rotatably mountable to the first door 31 and configured to be rotatable on the first door 31 to cover a gap between the first door 31 and the second door 32, and the rotating bar 100 may include a cam device 200 couplable to the first door 31, a rotating bar body 300 couplable to the cam device 200 and configured to be rotatable, and a rotating bar magnet 310 magnetically interacting with the first door 31 and the second door 32, and the cam device 200 may include a fixed cam 220 including a fixed cam protrusion 222 arranged to form a fixed cam peak 2221 and a fixed cam valley 2222 along a rotational direction of the cam device 200, and a rotary cam 230 including a rotary cam protrusion 232 arranged to form a rotary cam peak 2321 and a rotary cam valley 2322 along the rotational direction of the cam device 200, wherein the rotary cam 230 is configured to rotate between a first position P1 in which the rotary cam peak 2321 is disposed to correspond to the fixed cam valley 2222 when the first door 31 is closed, and a second position P2 in which the rotary cam peak 2321 is disposed to correspond to a different fixed cam valley 2222 adjacent to the fixed cam valley 2222 when the first door 31 is open.

Although the above technical ideas of the disclosure have been described by way of specific embodiments, the scope of the disclosure is not limited to these embodiments. Various modifications and variations that can be made by those skilled in the art without departing from the technical ideas of the disclosure as set forth in the claims of the patent will be deemed to be within the scope of the disclosure.

1. A refrigerator comprising:
a main body including a storage compartment;
a first door and a second door rotatably connected to the main body to open or close the storage compartment; and
a rotating bar coupled to the first door so as to be rotatable with respect to the first door about an axis of rotation, and configured to cover a gap between the first door and the second door when the first door and the second door are both closed, wherein the rotating bar includes:
a cam device coupled to the first door, and including:
a hinge protrusion coupled to the first door,
a fixed cam connected to the hinge protrusion and centered on the axis of rotation,
a rotary cam that is rotatable with respect to the fixed cam about the axis of rotation, and
an elastic member centered on the axis of rotation and configured to elastically contact the fixed cam with the rotary cam so that linear motion of the rotary cam is converted into rotary motion of the rotary cam by the contact of the fixed cam with the rotary cam, and
a rotating bar body coupled to the cam device so that rotation force formed by the rotary motion of the rotary cam transferred to the rotating bar body to rotate the rotating bar.

2. The refrigerator of claim 1, wherein
the rotating bar body includes an insulating space corresponding to the gap between the first door and the second door, an insulating material in the insulating space, and a rotating space between the hinge protrusion and the insulating space, and
the fixed cam, the rotary cam, and the elastic member are in the rotating space.

3. The refrigerator of claim 2, wherein
the cam device further includes a rotary cam housing covering an outer circumferential surface of the rotary cam, and
the elastic member is configured so that one end of the elastic member is supported on an inner surface of the rotary cam housing, and another end of the elastic member is supported on the rotary cam so as to apply an elastic force on the rotary cam.

4. The refrigerator of claim 3, wherein
the fixed cam includes:
a fixed cam body connected to the hinge protrusion, and
a fixed cam protrusion forming a fixed cam peak and a fixed cam valley along a circumferential direction of the cam device at an end of the fixed cam body, and
the rotary cam includes:
a rotary cam body forming an exterior of the rotary cam, and
a rotary cam protrusion forming a rotary cam peak and a rotary cam valley along the circumferential direction of the cam device.

5. The refrigerator of claim 4, wherein
the rotary cam is configured to rotate between a first position where the rotary cam peak is arranged to correspond to the fixed cam valley when the first door is closed, and a second position where the rotary cam peak is arranged to correspond to another fixed cam valley adjacent to the fixed cam valley when the first door is open, and
the elastic member is arranged such that the elastic force is maximum at a critical position where the fixed cam peak and the rotary cam peak correspond to each other between the first position and the second position of the rotary cam.

6. The refrigerator of claim 5, wherein
the rotary cam includes a guide protrusion protruding from an outer circumferential surface of the rotary cam body, and
the rotary cam housing includes a guide groove recessedly formed to correspond to the guide protrusion to allow the guide protrusion to be moved in a direction in which the axis of rotation extends.

7. The refrigerator of claim 5, wherein
the cam device further includes a connecting rib protruding from an outer surface of the rotary cam housing and configured to simultaneously rotate the rotary cam housing and the rotating bar body, and
at least a portion of the connecting rib is supported on a portion of the rotating bar body.

8. The refrigerator of claim 5, wherein
the cam device further includes a cam coupling body configured to prevent the rotary cam and the rotary cam housing from being separated by an elastic force of the elastic member, and
at least a portion of the fixed cam body is between the cam coupling body and the rotary cam housing.

9. The refrigerator of claim 5, wherein
the fixed cam protrusion includes a first anti-friction groove configured to reduce an area of an inclined surface formed between the fixed cam peak and the fixed cam valley so as to reduce friction due to contact between the fixed cam protrusion and the rotary cam protrusion, and
the rotary cam protrusion includes a second anti-friction groove configured to reduce the area of an inclined surface formed between the rotary cam peak and the rotary cam valley so as to reduce friction due to contact between the rotary cam protrusion and the fixed cam protrusion.

10. The refrigerator of claim 5, wherein
the rotating bar further includes a rotating bar magnet that magnetically interacts with the first door and the second door, and a heating member between the rotating bar magnet and the rotating bar body to prevent dew condensation on an outer surface of the rotating bar, and
the rotating bar body includes a plastic material in a portion of the rotating bar body that is adjacent to the heating member and the rotating bar magnet.

11. The refrigerator of claim 10, wherein
the first door includes a first door gasket configured to apply a sealing force between the first door and the main body and the first door and the rotating bar, and
the first door gasket includes a first gasket magnet configured to be coupled by magnetic interaction with the rotating bar magnet.

12. The refrigerator of claim 11, wherein
the second door includes a second door gasket configured to apply a sealing force between the second door and the main body and the second door and the rotating bar, and
the second door gasket includes a second gasket magnet configured to be coupled by magnetic interaction with the rotating bar magnet.

13. The refrigerator of claim 12, wherein
the first gasket magnet and the second gasket magnet are arranged to have the same magnetic poles facing the main body, and
the rotating bar magnet is a three-pole magnet in which a magnetic pole which is the same as magnetic poles of the first gasket magnet and the second gasket magnet corresponding to the rotating bar magnet is arranged in a middle of the three-pole magnet and other magnetic poles which are opposite to the magnetic poles of the first gasket magnet and the second gasket magnet are arranged on sides of the three-pole magnet.
